(19) United States
(12) Patent Application Publication
(10) Pub. No.: US 2004/0223515 A1
(43) Pub. Date: Nov. 11, 2004

(54) Method and apparatus for the synchronization of a system time of a communications network with a clock reference

(76) Inventors: Ronald E. Rygielski, Peoria, AZ (US); Steven C. Ramsdell, Phoenix, AZ (US); David I. Kirk, Phoenix, AZ (US)

Correspondence Address: Tony Miologos, Esq., Honeywell International Inc., Law Department, AB2, P.O. Box 2245, Morristown, NJ, 07962-2245, US

(21) Appl. No.: 10/757,039

(22) Filed: Jan. 14, 2004

Related U.S. Application Data
(60) Provisional application No. 60/440,242, filed on Jan. 14, 2003.

(51) Int. Cl. H04J 3/06

(52) U.S. Cl. 370/503

(57) ABSTRACT

A system and method for controlling a time synchronization relationship between a communications network time and a module located at a node connected to the communications network for providing a module reference time, the method including determining a time synchronization function is enabled, determining a time difference between the communications network time and the module reference time provided by the module, determining that the determined time difference is greater than a first limit, and less than or equal to a second limit; and gradually adjusting, automatically, the network communications network time to synchronize with the module reference time over a predetermined synchronization interval.

### CROSS REFERENCE TO RELATED APPLICATIONS

This application claims priority to U.S. Provisional Application Ser. No. 60/440,242, filed on Jan. 14, 2003 for Applicants Rygielski et al.

### BACKGROUND OF THE INVENTION

1. Field of the Invention

The present invention relates to network timing synchronization. More particularly, the present invention relates to a method and apparatus for controlling the relationship between a reference clock and a system time of a communications network in a precise manner within a predetermined degree of accuracy.

2. Description of the Related Art

Communications networks and the nodes thereof very often need to be synchronized so that processing tasks are scheduled and executed in an orderly and sequenced manner in order to avoid conflicts in communication and/or execution of tasks. Various time synchronization techniques have been proposed in the past. Some of these systems and methods reset either the network system time to match the time provided by the node reference timing signal or vice versa. However, the resetting of the time between the network and the nodes thereon may result in non-linear adjustments in the network and/or node reference time. In an attempt to synchronize the network time and the node reference time, some of the previous systems and methods resulted in non-uniform gaps and reversals of time content.

Also, there are instances when the time may need adjusting to compensate for a rather large or abrupt change in time from the current time to a desired time. For example, to compensate for daylight savings time, an adjustment of one hour may be required. In these instances, some of the heretofore systems and methods for network time synchronization have to be adjusted manually. Such a proposition may pose considerable costs on the communications network in terms of system availability, reliability, and accuracy during the (manual) resetting of the network time.

There are also some communications network environments wherein the network is segmented into a number of clusters. In such a network configuration, there is a need to synchronize the network time and the reference time of the nodes distributed throughout the various segments of the communications network.

Therefore, there exists a need to provide a synchronization method and apparatus for controlling the relationship between the communications network system time and a reference clock in a smooth and precise manner. Accordingly, it would be beneficial for a system and method for synchronizing the communications network time and the time of the node reference time to automatically make the adjustments to the relationship of the communications network time and the node reference time. There also exists a need for the time relationship adjustments to automatically compensate and adjust for specific time variances such as daylight savings time.

### SUMMARY OF THE INVENTION

The present invention provides a method for controlling a time synchronization relationship between a communications network time and a module located at a node connected to the communications network for providing a module reference time, the method includes determining a time synchronization function is enabled, determining a time difference between the communications network time and the module reference time provided by the module, determining that the determined time difference is greater than a first limit, and less than or equal to a second limit, and gradually adjusting, automatically, the network communications network time to synchronize with the module reference time over a predetermined synchronization interval.

The system of the present invention provides a module for controlling a time synchronization relationship between the communications network time and the module reference time of a node connected to the communications network, the module includes a processor, a network interface for providing a communication interface to the communications network, a bus interface for providing a communication interface to a host processor, and a system clock subsystem for providing the module reference time and for controlling the time synchronization functionality to reduce a time difference between the communications network time and the module reference time.

The above and other advantages and benefits of the present invention will be understood by reference to the following detailed description and appended sheets of drawings.

### BRIEF DESCRIPTION OF THE DRAWINGS

FIG. 1 is a schematic block diagram of an exemplary communications network environment for the system and method of the present invention;

FIG. 2 is block diagram illustrating portions of an exemplary module of a communications network;

FIG. 3 is an exemplary communications network suitable for the system and method of the present invention;

FIG. 4 is a flow diagram illustrating portions of the method of the present invention;

FIG. 5 is an exemplary configuration menu screen, in accordance with the system and method of the present invention;

FIG. 6 depicts an exemplary Accumulated Seconds Register that contains the current time in seconds;

FIG. 7 depicts an exemplary Interpolation Register for containing the fractional part of the current second;

FIG. 8 depicts an exemplary status register;

FIG. 9 depicts an exemplary command register; and

FIG. 10 illustrates a corresponding listing of command operation codes for the command register of FIG. 9.

### DETAILED DESCRIPTION OF THE INVENTION

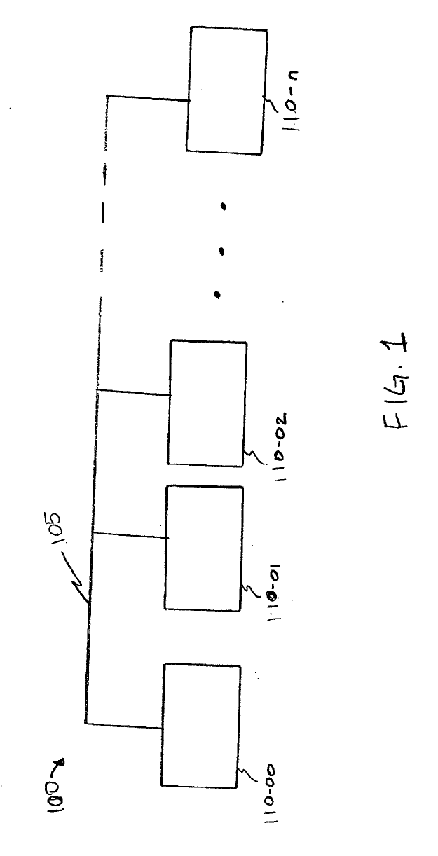

Referring to the drawings and in particular to FIG. 1, there is provided an exemplary network environment 100 applicable for implementation of the present invention of a method and system for synchronization of a communications network system time and a clock reference. Modules 110-00, 110-01 to 110-n, where n is an integer, are interconnected to communicate with each other over network control bus 105. Each of the modules 110-00 to 110-n of communications network 100 are preferably the equivalent of each other, i.e., capable of performing the same functions. Each of the modules 110-00 to 110-n preferably receives all signals transmitted from any of the other modules 110-00 to 110-n via bus 105. In one aspect of the present invention, the signals transmitted over bus 105 are broadcast to all of the modules 110-00 to 110-n.

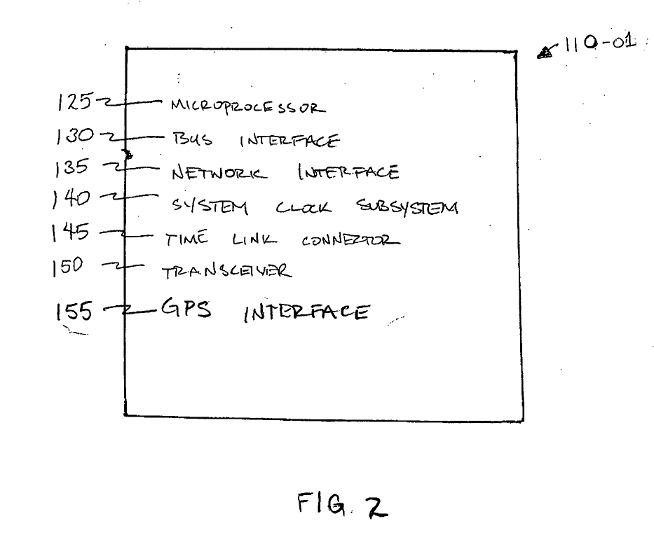

Each module 110, such as module 110-01 shown in FIG. 2, includes a microprocessor 125 for carrying out the processing functionality of the module as determined by instructions from local memory and/or instructions from other of the modules or other networked and interface components. Modules 110 are preferably implemented as a processor board interfaced with a PC (personal computer). Accordingly, module 110-01 has a bus interface 130 for connecting to a communications interface slot of the PC, such as an industry standard PCI slot. The module includes a network interface 135 for interfacing and connecting to communications network 100. Transceiver 150 provides a connection to communications network 100 for receiving and transmitting signals. Module 110-01 includes a system clock subsystem 140 for generating and controlling the timing aspects of the module. A time link connector 145 is preferably included for connecting a number of the modules together such that timing signals may be communicated between the various modules 110-00 to 110-n. Time link 145 may be used to provide, optionally, interface capabilities with a GPS (Global Positioning Satellite) reference timing signal.

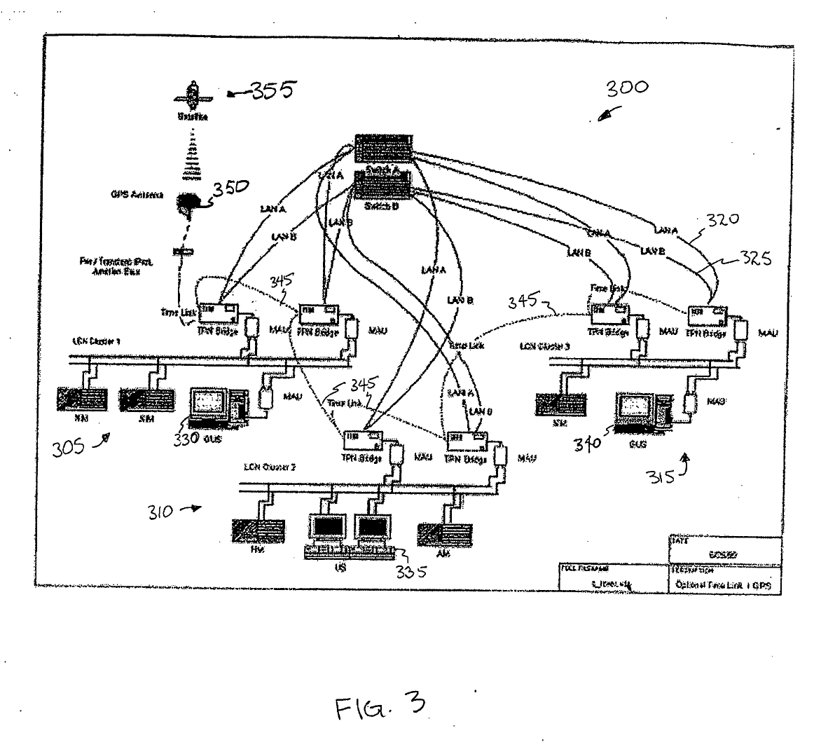

In one aspect of the present invention, modules 110 are connected to dually redundant buses LAN A 320 and LAN B 325 as illustrated in the exemplary communications network of FIG. 3, such as a plant local control network 300. Local control network 300 is preferably segmented into local control network clusters 305, 310, and 315. Modules 110, each embodied as a processor board, are plugged into a PCI slot of a PC based bridge and operates as a PCI target device. The PC based bridges are networked for communication with each other over dually redundant LAN A 320 and LAN B 325. In this manner, although network 300 is segmented, the various clusters of 300 network are interconnected for communication. The network interface 135 preferably also provides the connection for the reception and transmission of time synchronization data.

Time link 345 connects the modules 110 of local control network 300 together for routing and sharing of timing information between the modules 110. For instance, time link 145 can be utilized to limit the drift or skew between modules 110 and reception of the GPS reference timing signal.

In an aspect of the present invention, time synchronization is provided as a function of the local control network 100, 300. The communications network 100, 300 is periodically synchronized to the time of a network module 110. Accordingly, the module 110 time is periodically pushed onto the communications network 100, 300. To facilitate the time synchronization, one of the modules is designated a master, one a slave, and the other networked modules are designated as listeners. The slave module provides functional redundancy for the master module in the instance the master fails or is otherwise incapable of performing the master system clock subsystem functions. It is preferred that a switch-over to the slave module from the master module is transparent regarding the time synchronization of the network time and the local time.

Regarding system clock subsystem 140, the system clock subsystem operates to synchronize the local time of the module 110 (e.g., 110-01) to network 100, 300 for the purpose of, for example, maintaining accurate scheduling of tasks, including the monitoring and archiving of an error history. In a preferred aspect hereof, system clock subsystem 140 maintains the current time in a seconds/100 μs format, which is distributed to the other modules 110 to maintain the synchronization between the local control network connected nodes (e.g., modules 110). System clock subsystem 140 maintains the accurate timing signal for the communications network, (e.g. plant control network 300), distributes the timing signal to the communications network 100 and 300, interprets the signals received over the network, and provides the time reference to the module processor and the bridge kernal level driver.

The communication to microprocessor 125 may be accomplished, preferably, by precisely spaced interrupts at 50 msec and 1 second intervals. A time interpolations resister for monitoring the number of 100 μs intervals since the last second rollover is also provided as part of the system clock subsystem.

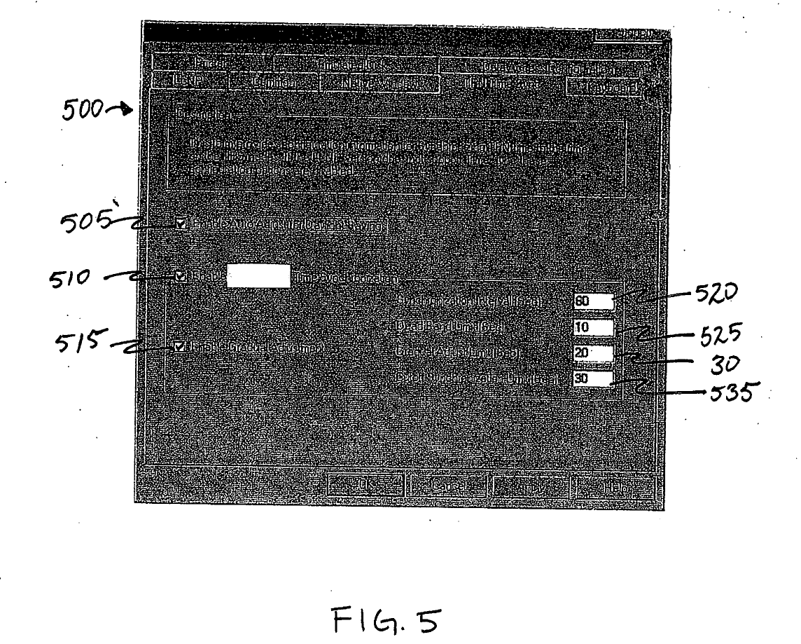

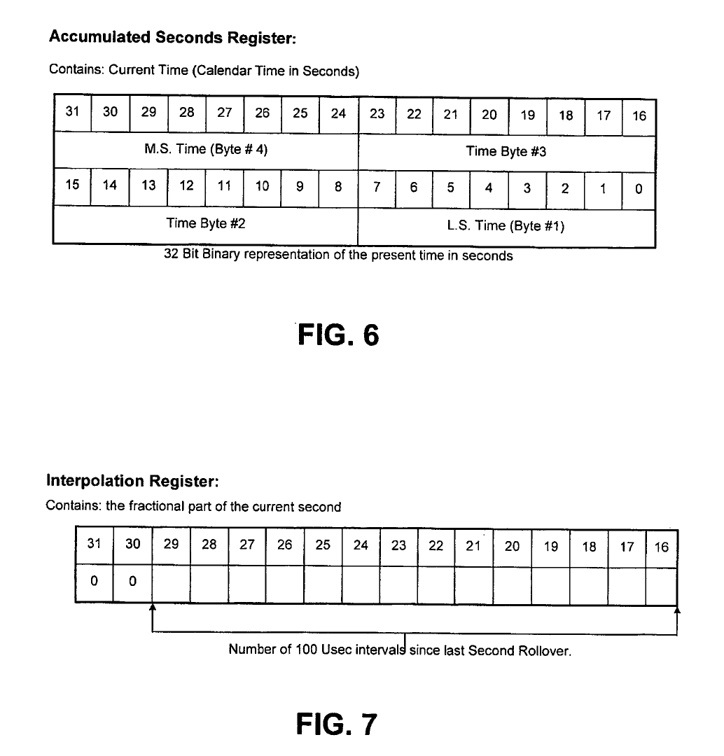

In aspect of the present invention, hardware/firmware elements of a command interface and programmable clock driver chain are provided so as to allow a user to “fine tune” the frequency of timer interrupts of an included real time clock micro-controller. A better understanding of how the gradual adjust functions and aspects of the present invention are implemented may be had by referring to exemplary FIGS. 6-10 of the real time clock subsystem hardware register definitions pertaining to the present invention.

FIG. 6 depicts an exemplary Accumulated Seconds Register that contains the current time in seconds (i.e., the calendar time in seconds). As shown, the current time can be represented by a 32 bit binary representation of the present time in seconds.

FIG. 7 shows an exemplary Interpolation Register for containing the fractional part of the current second. As shown, register locations are provided for the number of 100 microsecond intervals since a last second rollover.

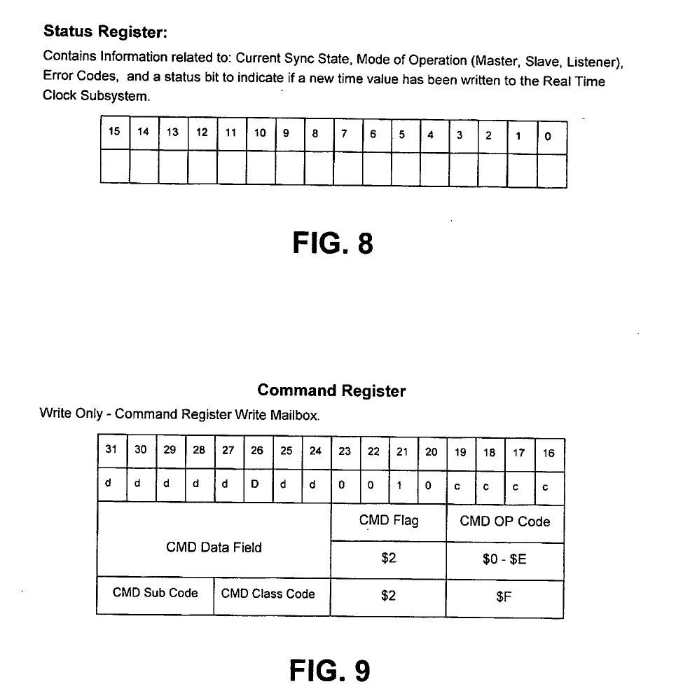

FIG. 8 shows an exemplary statutes register for containing, inter alia, data related to the current sync state, mode of operation (e.g., master, slave, or listener), error codes, and a status bit indicative of whether a new time value has been written to the Real Time Clock Subsystem of the present invention.

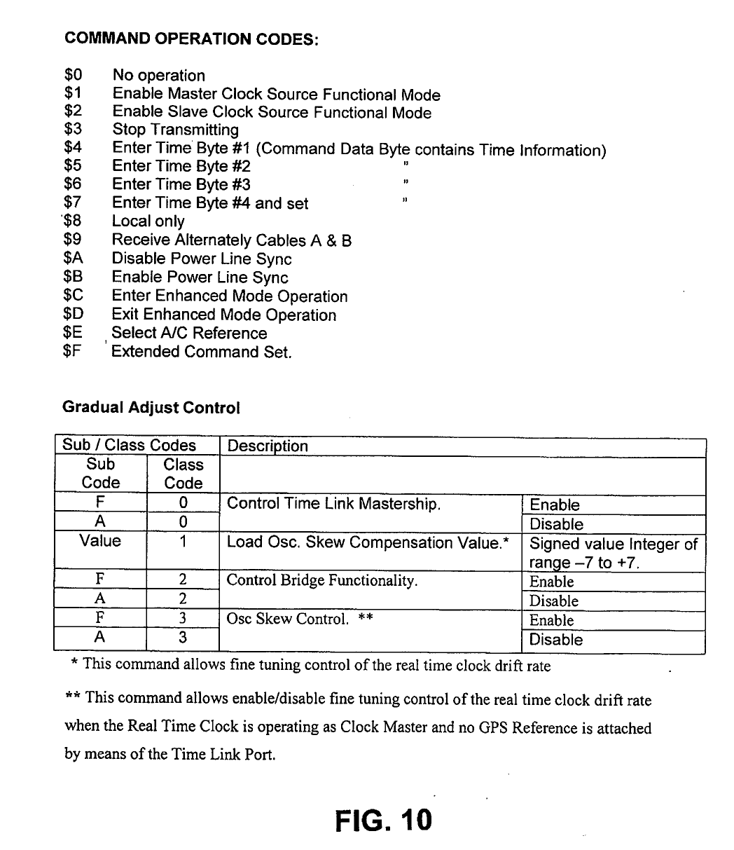

FIG. 9 depicts an exemplary command register and FIG. 10 illustrates a corresponding listing of command operation codes for the command register of FIG. 9. FIG. 10 includes definitions for the extended command set, $F, gradual adjust control.

In accordance with the present invention, the method and system of herein provides a method for providing system time synchronization across local control networks segments 305, 310, and 315. The current system time (i.e., calendar time) originates from the module 110 designated as the master clock source. Every other module 110 maintains a local copy of the current time, preferably within a 100 μs resolution. Each slave module is preferably synchronized to the clock of the master module (i.e., the master clock). In one embodiment hereof, the local time bases are maintained at a non-synchronized drift rate of ±32 ppm±2.76 sec/day until synchronization is re-established. The system synchronization is preferably automatically maintained by software and does not require user intervention or initiation.

The amount of time skew permitted between local network segments may be limited based on the particular implementation and context of application for the present application. For example, if an application requires a low amount of skew (e.g., <16 msec) between network segments then time link cables 345 may be used to daisy chain time link connectors of modules 110 together. For an application where the amount of skew between modules is less critical, then the use of the time link cables 345 may be avoided.

For an added measure of stability, GPS interface 155 may be connected to the GPS antenna 350 to receive the GPS reference signal obtained from GPS satellite 355 for receiving a stable, reliable timing signal.

In the instance that a low skew (e.g., ±300 μsec) between modules 110 is desired, then time link connector 145 can be connected to time link cable 345 and GPS interface 350 can be connected to GPS antenna 350.

In one embodiment hereof, the system clock subsystem uses 5 MBPS time sync frames for maintaining network time synchronization. The 5 MBPS time sync frames are generated by the master clock designated module at 1 second intervals. The master module acts as a transmitter of the system-wide real time clock data and the slave and listener modules act as receivers of the time sync frame transmissions.

The module 110 transmitting the 5 MBPS time sync frames is designated the master clock via a personality software control. The clock operating as the master is instructed to generate an interrupt each 1 second period, and when a time set occurs to the Kernel firmware. The Kernel firmware initiates a 5 MBPS time sync frame in response to this 1 second periodic interrupt. The designated slave clock acts as a backup for the master clock. Software preferably controls the selection of the master and slave clocks and handles the switchover of the transmit function through control of a master/slave relationship, including an initial startup selection and all failure scenarios.

In the event of a loss of a clock source, the time information is updated locally during the unsynchronized period to continue in an uninterrupted manner based upon the last valid time data received prior to the failover.

Upon the establishment of the module/node load, the first module 110 preferably establishes itself as the master time reference source by trying to detect a clock on LAN A and LAN B. Since the module will be the first clock source, it will not detect a clock source and will thus assume the role as the master module. After establishing itself as the master, the module does not listen but instead broadcasts its time synchronization message (i.e., reference time) periodically, preferably once every second.

The second module loaded onto the network will detect a clock on both LAN A and LAN B and will thus become a slave. The slave module listens for and receives time synchronization message from the master module to synchronize its clock thereto. The slave does not normally transmit its clock time onto the network unless the master module fails. The transition from master clock reference to slave clock reference should be smooth and virtually transparent since the slave was tracking the master modules clock source.

When the master clock is commanded to accept new seconds time data, all listener nodes to this time transmission, including the slave clock source use the newly transmitted clock data to update their internal time registers. Time can only be reset to one second accuracy and on one second boundaries. Listener modules 110 that receive a time frame wherein the seconds data is a different value than what is expected, will be updated with new seconds data.

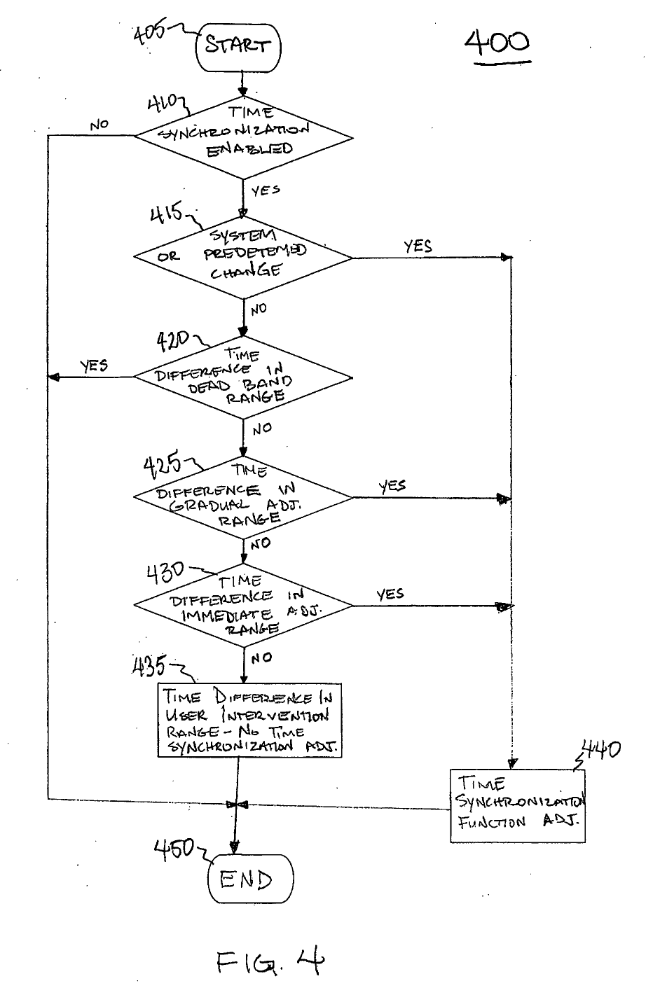

A flow diagram illustrating an exemplary process used by the present invention to automatically synchronize the communications network 100, 300 time to the reference time of the modules 110 is shown in FIG. 4.

In an aspect of the present invention, the reference time provided by module 110 designated as the master may be generated or obtained by the system clock subsystem 140 from a local crystal oscillator, from a time synchronizations functionality of an operating system of the PC in which the master module 110 is interfaced with, or from an independent source such as a GPS signal. The communications network time and the module 110 time are periodically read to determine the synchronization between the two time signals. In one embodiment of the present invention, this period is once every one (1) second. If the determination is made that there is a time difference greater than a predetermined limit, then the time synchronization process of FIG. 4 is invoked.

Referring to FIG. 4, the time synchronization functionality of the present invention is preferably enabled or disabled at the preference of a user. The user may be a network administrator for the communications network 100, 300. It should be noted that the time synchronization may, as a default, be enabled or disabled. Thus, at step 410 a determination is made whether the time synchronization functionality of the present method and system is enabled. If not enabled, then process 400 proceeds to the end at step 450. In the instance the time synchronization functionality is enable, then process 400 proceeds to step 415.

At step 415, a determination is made whether a system or predetermined time change is required. That is, the determination is made whether a module 110 becomes a master module, whether a predetermined next synchronization interval occurs, whether a network configuration change occurs, whether a Demand Time Sync Request is made, whether a Set Network Control Time to Module/Node Time Request is made, or whether a Daylight Savings Time change occurs. If any of these conditions are met then process 400 proceeds to step 440 where a time synchronization function adjustment is invoked. In the event a system or predetermined time change is not required as determined at step 415, then process 400 proceeds to step 420.

At step 420, a determination is made whether the time difference between the communications network time and the module 110 time (i.e., reference) is in a Dead Band Range. Time differences greater than zero and less than a Dead Band limit do not require any action by the time synchronization function. The Dead Band limit is preferably set at or below a threshold value above which the operations of the communication network would be adversely affected. The Dead Band limit should therefore represent a relatively insignificant time difference as far as network communication, scheduling and operations are concerned. That is, the Dead Band limit is set to allow for tolerable differences in the network time and the module 110 time.

It is noted that any Gradual Adjustment in effect at the time the time difference is equal to or less than the Dead Band limit (i.e., the time difference is between zero time difference and the dead bane limit) will remain in effect until the time difference is too small for a Gradual Adjustment correction over the next time sync interval.

In the event the time difference between the communications network time and the module 110 time is in the Dead Band range at step 420, then process 400 proceeds to step 450. However, if the time difference between the communications network time and the module 110 time is not in the Dead Band range, as determined at step 420, then process 400 proceeds to step 425.

At step 425, a determination is made whether the time difference between the communications network time and the module 110 time exceeds the Dead Band range but is less than a Gradual Adjustment limit or a Cutoff Synchronization limit, whichever is lesser. Time differences determined to be greater than the Dead Band limit and less than the smaller of the Gradual Adjustment limit or the Cutoff Synchronization limit are within a Gradual Adjustment range. Time differences within the Gradual Adjustment range are corrected gradually by the time synchronization function at step 440. The gradual adjustment of the network time to match the module 110 time prevents the abrupt loss of network history data and minimizes the impact to sequence of events logging that may be caused by an immediate time change.

The time synchronization function at step 440 determines the rate at which the gradual adjustment of the time is applied to the network time. Preferably, the time adjustments are applied smoothly over a period of time, such as a day, at a rate of 1 sec/day to 8 sec/day. By adjusting the network time gradually, the impact to the sequence of events logging is minimized and the abrupt loss of network history data is avoided. The time synchronization function at step 440 uses a gradual adjustment algorithm to automatically calculate the rate of change value for the gradual adjustment based on, in one aspect hereof, the time difference and the synchronization interval. The rate of correction is calculated to complete the time correction over the configured synchronization interval. The maximum rate of correction may be limited to, for example, 8 sec/day.

For example, if the synchronization interval is configured for 12 hours and a 2 second time difference is detected, then the time synchronization function at step 440 operates to correct the 2 second time difference over the next 12 hour cycle.

The calculated rate of change will remain in effect until the next scheduled synchronization interval unless the time synchronization function detects a time sync configuration change, a Daylight Savings Time change, a Demand Time Sync Request change, or a Set Network Control Time to Module/Node Time Request change is detected. If any of these events occurs, then the rate of change is recalculated and reapplied by the time synchronization function adjustment, step 440.

If it is determined at step 425 that the time difference is not in the Gradual Adjustment range, then process 400 proceeds to step 430. At step 430, a determination is made whether the time difference is in an Immediate Adjustment range. In the instance the time difference is in the Immediate Adjustment range, process 400 proceeds to step 440 to immediately change the communications network time to match that module 110 time. This immediate time correction is in contrast to the gradual adjustment of the communications network time invoked when the time difference is in the Gradual Adjustment range, as determined at step 425. In the Immediate Adjustment range, applying the gradual adjustment is expected to take too long. Thus, adjusting the network time immediately is done.

The Immediate Adjustment range is defined as a time difference greater than the Gradual Adjustment limit and below or equal to a Cutoff Synchronization limit. The Cutoff Synchronization limit is a time difference for which a gradual or immediate adjustment of the network time is deemed unacceptable.

In the instance the time difference is not in the Immediate Adjustment range but instead exceeds the Cutoff Synchronization limit, process 400 proceeds to step 435 and is considered to be in a User Intervention range. The Cutoff Synchronization limit is preferably user configurable. If the time difference exceeds the Cutoff Synchronization limit then a user-initiated mechanism is provided through a user interface so that the user can initiate a network time synchronization.

The user may initiate an immediate communications network time adjustment by selecting to invoke the Set Network Time to Module/Node Time operation. The Set Network Time to Module/Node Time operation is preferably only enabled at the module 110 designated as the master for selection by an authorized user. Since an immediate change of the network time may cause disruptions in the history and error logging, a warning message may be displayed to the user via the user interface to warn the user that such an immediate network time change may cause an abrupt loss of history data.

In one aspect of the present invention, a warning-level event is logged by PC interfaced with the master module to indicate an immediate change in network time occurred. This provides a measure of explanation in the event that the immediate change of network time does result in a loss of history data.

In yet another aspect of the present invention, the user may manually adjust the time difference to be equal to or less than the Cutoff Synchronization limit. By doing so, process 400 will proceed to act on the time difference, as discussed above. Preferably, the user can also invoke the Demand Time Sync operation at the master module to avoid waiting for the next scheduled time sync interval. The Demand Time Sync operates exactly like a scheduled time sync and resets the interval scheduling.

Redundancy for the time synchronization functionality of the present invention is provided by having at least two modules/nodes on communications network 100, 300 configured as clock sources. As stated previously, one module 110 is designated as the master, at least one module 110 is designated as the slave, and the other modules 110 are configured as listeners. The slave(s) provide backup for the master in the event the master fails. The time sync functionality only actively corrects time on the master module. The other modules are updated by the timing signal received from the master module. It is preferred that the time synchronization function performs some level of monitoring of module 110 activity to prepare the non-master modules for assuming the role of the master.

In another aspect hereof, the master and slave modules are configured the same so that a failover to the slave module does not change the communications network 100, 300 time sync configuration parameters. In the event that the slave and master modules are not set-up exactly, then the time synchronization parameters on the (newly) designated master will be used. In one embodiment of the invention, the time synchronization parameters may be shared between modules.

In one aspect of the present invention, a user interface is provided to effectuate the configuration and monitoring of the time synchronization function. Since modules 110 are preferably implemented as processor boards interfaced with a PC, the user interface may be graphical menu (i.e., window) as part of a graphical user interface. FIG. 5 illustrates an exemplary graphical menu 500 that is preferably available as a tab on a network configuration utility. Access to the Time sync configuration page 500 is preferably limited to authorized users.

In one aspect of the present invention, any change to the time synchronization configuration will cause the time sync function to execute immediately based on the new configuration settings. Thereafter, the time sync function will operate on a periodic basis specified in the synchronization interval 535.

The Enable Time Synchronization checkbox 510 must be checked for the time sync function to be enabled. The selection of this checkbox is verified at step 410 of FIG. 4. By default, Enable Time Synchronization checkbox 510 may be unchecked.

The Enable Gradual Adjustment checkbox 515 is selected to enable the gradual adjustment of the network time as discussed above. By default, Enable Time Synchronization checkbox 510 may be checked.

The Enable Auto Adjust for Daylight Savings checkbox 505 is selected to enable the immediate adjustment of the network time to compensate for daylight savings time changes, as discussed above. By default, Enable Auto Adjust for Daylight Savings checkbox 505 may be unchecked. If enabled and invoked, the automatic adjustment for daylight savings time functionality supersedes any gradual adjustment that may be in effect by the system and method herein. Preferably, the Enable Auto Adjust for Daylight Savings checkbox 505 is independent of Enable Time Synchronization checkbox 510.

When the Enable Auto Adjust for Daylight Savings checkbox 505 is checked (i.e., selected) and a Daylight Savings Time event occurs, the network time is will immediately be changed to the match the master module's reference time, regardless of the synchronization interval or the Cutoff Synchronization limit or the Gradual Adjustment limit.

The Synchronization Interval box 520 value is applicable when the Enable Synchronization checkbox 510 is checked. It provides a mechanism for the user to set the synchronization interval, preferably between 1 and 99999 seconds with 3600 seconds (1 hour) being a preferred default value.

Dead Band limit box 525 provides a mechanism for the user to specify the Dead Band limit, the time difference for which the time synchronization function will take no action. Per process 400, the Dead Band limit cannot be greater than the Gradual Adjustment limit, provided the Gradual Adjust is enabled at checkbox 515. The Dead Band limit may have a default of 2 seconds.

The Gradual Adjust Limit box 530 is applicable when the Gradual Adjust checkbox 515 is enabled. Preferably, the Gradual Adjust box may be set to a value between 1 and 99999 seconds. By default, the Gradual Adjust box is set to 10 seconds.

The Cutoff Synchronization limit box 535 is provided to allow for the setting of the time difference limit above which the time synchronization feature will not automatically reset the communications network time. The range for this limit is preferably 1 to 99999 seconds. In accordance with process 400, the Cutoff Synchronization limit is greater than the Gradual Adjust limit when the Gradual Adjust is enabled or greater than the Dead Band limit when the Gradual Adjust is not enabled. By default, the Cutoff Synchronization limit may be set to 99999 seconds (i.e., ≈27.5 hours).

In accordance with the present invention, the user interface preferably provides at least a portion of a display screen for providing a status of the time synchronization function of the present invention. For example, the status screen will preferably display whether the time sync function is enabled, the status of a particular node (e.g., master, slave, or listener), the current communications network time, the current module/node time, the last time a time sync operation occurred, and the category or range for the time difference (e.g., Dead Band, Gradual Adjust, etc.).

As briefly mentioned above, preferably a Set Network Time to Module/Node Time function is provided for by the present invention. Such functionality is preferably presented to the user via the user interface aspects hereof to facilitate the user initiating an action to immediately synchronize the network time to the master module's reference time. However, this functionality is preferably not enabled on any modules other than the master module. The interval scheduling will be reset and any Gradual Adjustment in effect will be eliminated when the Set Network Time to Module/Node Time action is initiated.

There is also preferably provided an Demand Time Sync function that enables the user to initiate, on the master module, to force a network time sync without having to wait for the next time sync interval to occur.

In an aspect hereof, the gradual adjustment of the communications network discussed above may be disabled or not implemented in an implementation of the present invention. In such a configuration, time differences greater than the Dead Band limit are adjusted immediately.

It should be understood that the foregoing description is only illustrative of a present implementation of the teachings herein. Various alternatives and modification may be devised by those skilled in the art without departing from the invention. For example, the time synchronization system and method of the present system may be implemented by a computer readable storage medium (e.g., a removable storage medium, a memory card or a hard disk) having program instructions embodied therein for executing the methods of the present invention. The computer readable storage medium can be read and the program instructions executed by a processor. Accordingly, providing a time synchronization system and method can be accomplished by program instructions for program instructions for determining a time synchronization function is enabled, program instructions for determining a time difference between the communications network time and the module reference time provided by the module, program instructions for determining that the determined time difference is greater than a first limit, and less than or equal to a second limit, and program instructions for gradually adjusting, automatically, the network communications network time to synchronize with the module reference time over a predetermined synchronization interval.

Various variations and modifications may be made to the invention, with the attainment of some or all of the advantages of the invention as indicated in the claims appended hereto. Accordingly, the present invention is intended to embrace all such alternatives, modifications, and variances that fall within the scope of the appended claims

What is claimed is:

1. A method for controlling a time synchronization relationship between a communications network time and a module located at a node connected to said communications network for providing a module reference time, said method comprising:
determining a time synchronization function is enabled;
determining a time difference between said communications network time and said module reference time provided by said module;
determining that said determined time difference is greater than a first limit, and less than or equal to a second limit; and
gradually adjusting, automatically, said network communications network time to synchronize with said module reference time over a predetermined synchronization interval.

2. The method of claim 1, wherein said gradually adjusting results in a reduction of said time difference between said communications network time and said module reference time that is substantially constant and without a time reversal.

3. The method of claim 1, further comprising:
determining a system change is requested; and
in response to said system change request, immediately synchronizing, automatically, said communications network time and said module reference time.

4. The method of claim 3, wherein said system change is selected from a group of actions consisting of: a module being initialized for providing said module reference time, a predetermined next synchronization interval occurring, a user-initiated time synchronization occurring, and a Daylight Savings Time event occurrence.

5. The method of claim 1, further comprising:
determining that said time difference between said communications network time and said module reference time is greater than a third limit that is greater than said second limit; and
in response to said time difference being greater than said third limit, taking no automatic action to synchronize said time difference between said communications network time and said module reference time.

6. The method of claim 1, wherein said module is designated a master module and only said master module provides said module reference time.

7. A storage medium having computer readable program instructions embodied therein for providing a method for controlling a time synchronization relationship between a communications network time and a module located at a node connected to said communications network for providing a module reference time, said storage medium comprising:
program instructions for determining a time synchronization function is enabled;
program instructions for determining a time difference between said communications network time and said module reference time provided by said module;
program instructions for determining that said determined time difference is greater than a first limit, and less than or equal to a second limit; and
program instructions for gradually adjusting, automatically, said network communications network time to synchronize with said module reference time over a predetermined synchronization interval.

8. The storage medium of claim 7, wherein said program instructions for gradually adjusting results in a reduction of said time difference between said communications network time and said module reference time that is substantially constant and without a time reversal.

9. The storage medium of claim 7, further comprising:
program instructions for determining a system change is requested; and
program instructions for, in response to said system change request, immediately and automatically synchronizing said communications network time and said module reference time.

10. The storage medium of claim 9, wherein said system change is selected from a group of actions consisting of: a module being initialized for providing said module reference time, a predetermined next synchronization interval occurring, a user-initiated time synchronization occurring, and a Daylight Savings Time event occurrence.

11. The storage medium of claim 7, further comprising:
program instructions for determining that said time difference between said communications network time and said module reference time is greater than a third limit that is greater than said second limit; and
program instructions for, in response to said time difference being greater than said third limit, taking no automatic action to synchronize said time difference between said communications network time and said module reference time.

12. A module for controlling a time synchronization relationship between a communications network time and a module reference time of a node connected to said communications network, said module comprising:
a processor;
a network interface for providing a communication interface to said communications network;
a bus interface for providing a communication interface to a host processor; and
a system clock subsystem for providing said module reference time and for controlling a time synchronization function to reduce a time difference between said communications network time and said module reference time.

13. The module of claim 12, wherein said time synchronization function of said system clock subsystem reduces said time difference substantially constant and without a time reversal.

14. The module of claim 12, wherein said time synchronization function of said system clock subsystem:
determines a time synchronization function is enabled;
determines said time difference between said communications network time and said module reference time provided by said module;
determines that said determined time difference is greater than a first limit, and less than or equal to a second limit; and
gradually adjusts, automatically, said network communications network time to synchronize with said module reference time over a predetermined synchronization interval.

15. The module of claim 14, wherein said time synchronization function of said system clock subsystem further:
determines a system change is requested; and
in response to said system change request, immediately synchronizes, automatically, said communications network time and said module reference time.

16. The module of claim 15, wherein said system change is selected from a group of actions consisting of: a module being initialized for providing said module reference time, a predetermined next synchronization interval occurring, a user-initiated time synchronization occurring, and a Daylight Savings Time event occurrence.

17. The module of claim 14, wherein said time synchronization function of said system clock subsystem further:
determines that said time difference between said communications network time and said module reference time is greater than a third limit that is greater than said second limit; and
in response to said time difference being greater than said third limit, takes no automatic action to synchronize said time difference between said communications network time and said module reference time.
